(19) United States
(12) Patent Application Publication
(10) Pub. No.: US 2013/0209108 A1
(43) Pub. Date: Aug. 15, 2013

(54) SYSTEM AND METHOD FOR PERSONALIZED HOTELING OF MOBILE WORKERS

(71) Applicants: Anjur S. Krishnakumar, Princeton, NJ (US); Shalini Yajnik, Berkeley Heights, NJ (US)

(72) Inventors: Anjur S. Krishnakumar, Princeton, NJ (US); Shalini Yajnik, Berkeley Heights, NJ (US)

(73) Assignee: Avaya Inc., Basking Ridge, NJ (US)

(21) Appl. No.: 13/396,586

(22) Filed: Feb. 14, 2012

(51) Int. Cl. H04B 7/00; H04B 5/00; H04B 10/10

(52) U.S. Cl. 398/130; 455/41.1; 455/39; 455/41.3

(57) ABSTRACT

Method to personalize a workspace, including: receiving via a first communication channel an information message comprising an identification of the workspace; sending via a second communication channel: an identity of a user; the identification of the workspace; and a request to personalize the workspace according to settings associated with the user; and sending via the second communication channel an optional confirmation message confirming a personalization of the workspace. Another embodiment to personalize a workspace may comprise: receiving a command from a user to personalize the workspace; sending via a first communication channel an information message comprising an identification of the workspace; and receiving personalization data via a second communication channel, wherein the personalization data is used to personalize the workspace.

### BACKGROUND

1. Field of the Invention

Embodiments in accordance with the present invention pertain to portably-personalized workspaces and, in particular, the transfer of workspace personalization from one location to another location.

2. Description of the Related Art

An office worker may work at various times at two or more locations, such as a conventional office and a home office, or conventional offices located in two or more separate locations, or a fixed location such as a conventional office and a mobile location such as a field site, or an employer's conventional office and a customer's conventional office. Or, a conventional office may be shared among two or more office workers who use it at non-overlapping times.

An office worker ordinarily will have an associated workspace. The workspace commonly will comprise computer-related resources such as a computer login interface, access to computerized tools and/or databases, either internally on an intranet or externally on the internet, and so forth. The workspace may also comprise resources, such as copier access, access to office services (e.g., librarian, technical support, etc.), physical access to certain locations, environmental preferences (e.g., office temperature, office lighting levels, etc.). The associated workspace may be personalized from one office worker to another, based on factors such as personal preference, employer-granted permissions and accesses, job requirements, and so forth.

If a single workspace is shared among more than one office worker, it may be cumbersome or time consuming to change the workspace parameters manually in accordance with the office workers' preferences, permissions, etc. Similarly, if a single office worker uses more than one single workspace, it may be cumbersome or time consuming to change the various workspace parameters in accordance with the office worker's preferences, permissions, etc. Such shared usage, either by multiple office workers of a single location or a single office worker of multiple locations, will be referred to herein as hoteling.

If the workspace is not sufficiently personalized, the office worker may be denied access to resources that he or she (generically, “they”) may be entitled to, or they may have access to resources they are not entitled to, or they may work less effectively or less efficiently because the workspace is not tailored to the office worker's preference. Solutions known in the related art may use smart cards, Bluetooth devices, or similar tokens to identify the mobile worker and to personalize the workspace environment. In some cases, the identity information may be entered manually. The use of Bluetooth devices and similar tokens requires prior association between the endpoints. Smart cards need to be provisioned per user and carried on person. In addition, smart card readers are needed at each location. Manual entry of identity information can become cumbersome if many devices are involved.

Present commercial practice is use of smart card like systems to provide office hoteling or hot-desking. An example of such a known system is the Sun Ray system sold by Oracle. Hot-desking with VoIP using smart cards is also known in the background art.

The Oracle Sun Ray non-smart card mobile (NSCM) capability uses a login-based approach at a computer to do hot-desking. A drawback of this approach is that in places where there is no PC (e.g., a hotel room environment), there is no terminal at which to enter login credentials and therefore the method does not work. Furthermore, a login requires physical access to a terminal that may be located behind locked doors.

The known art has drawbacks as discussed above. Therefore, a method and system is needed for improved personalization to support hoteling of office workers.

### SUMMARY

There is a need to customize the workspace associated with a mobile worker, no matter when and where they are. Embodiments in accordance with the present invention target the provisioning and personalization of workspaces for mobile workers in a way that is less cumbersome or time consuming than the known art. If a single workspace is shared among more than one worker, the workspace may be personalized in accordance with the office workers' preferences, permissions, etc. Similarly, if a single office worker uses more than one single workspace, the workspace may be personalized in accordance with the office workers' preferences, permissions, etc.

Embodiments in accordance with the present invention may also be useful for consumers who use or stay at another location, such as a hotel room, where customization of room preferences can be done in a fashion similar to that of the personalization of office workspaces.

Embodiments in accordance with the present invention provide a method to personalize a workspace, comprising: receiving via a first communication channel an information message comprising an identification of the workspace, and sending via a second communication channel: an identity of a user; the identification of the workspace; and a request to personalize the workspace according to settings associated with the user.

Embodiments in accordance with the present invention may provide a method to personalize a workspace, comprising: receiving a command from a user to personalize the workspace; sending via a first communication channel an information message comprising an identification of the workspace; and receiving personalization data via a second communication channel, wherein the personalization data is used to personalize the workspace.

Embodiments in accordance with the present invention may provide a system to personalize a workspace, comprising: a first, personalizable member comprising: a transmitter of a short-range communication channel, the transmitter configured to transmit an identification of the first personalizable member; and a communication interface configured to receive personalization data; a second member comprising: a receiver of the short-range communication channel; and a communication interface configured to transmit a personalization request and an identification of the second member; and a personalization server configured to personalize the workspace of the first member, in response to the personalization request from the second member.

Optionally, the system may further comprise a memory coupled to the processor, the memory configured to store instructions such that, when the instructions are performed by the processor, the processor performs the steps associated with the embodiments of the processes described herein.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments encompassed within the scope of the present invention, and, therefore, are not to be considered limiting, for the present invention may admit to other equally effective embodiments, wherein:

FIG. 1 illustrates a system to perform a workplace personalization in accordance with an embodiment of the invention;

FIG. 2 illustrates a transfer to a mobile device of a workspace identifier in accordance with an embodiment of the invention;

FIG. 3 illustrates a method and message exchange for personalization execution on a smartphone, when the personalization information resides on the smartphone, in accordance with an embodiment of the invention;

FIG. 4 illustrates a method and message exchange for personalization execution on a server, when the personalization information resides on the smartphone, in accordance with an embodiment of the invention;

FIG. 5 illustrates a method and message exchange for personalization execution on a server, when the personalization information resides on the server, in accordance with an embodiment of the invention; and

FIG. 6 illustrates a method and message exchange for personalization execution on a smartphone, when the personalization information resides on the server, in accordance with an embodiment of the invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “comprise”, “include”, “including”, and “includes” mean including but not limited to. To facilitate understanding, like reference numerals have been used, where possible, to designate like elements common to the figures. Optional portions of the figures may be illustrated using dashed or dotted lines.

### DETAILED DESCRIPTION

Embodiments in accordance with the present invention use readily available technology to simplify a process of personalizing a local environment used by a person. Embodiments may comprise the personalization of a workspace used by an office worker. Other embodiments may comprise the personalization of a living space, such as the home (or portion thereof such as a room), or a hotel room, etc. “Workspace” as used herein will refer to any such local environment unless indicated otherwise by the context of usage. The process of personalizing may comprise usage of a smartphone together with an information transfer channel.

Unlike some methods of the background art that require smart cards or the like, embodiments in accordance with the present invention allow for carrying a user's preferences in a mobile electronic device (e.g., a smart-phone). A personalization server may be set up in advance to know about the user and may have the user's preferences pre-stored for future use. Embodiments in accordance with the present invention may allow for personalization of a space, or for controlling access to a space, etc., by scanning a QR code displayed in the space and then allowing actions such as entering into the controlled space.

As used herein, the term “module” refers generally to a logical sequence or association of steps, processes or components. For example, a software module may comprise a set of associated routines or subroutines within a computer program. Alternatively, a module may comprise a substantially self-contained hardware device. A module may also comprise a logical set of processes irrespective of any software or hardware implementation.

Embodiments in accordance with the present invention are able to personalize a workspace without a prior association between the personalized workspace and a device carried by the mobile worker, such as an RFID tag, a transmitting fob, a smart phone or similar mobile device, and so forth. Avoiding a prior association avoids a need to pre-provision an identity of the mobile device into a PC or a backend server. Embodiments in accordance with the present invention may be useful when: (a) personalizing a workspace by transferring an identifier (e.g., a location identifier, a user-defined mnemonic, a Media Access Control (“MAC”) address, etc.) from a desktop platform to a mobile device (e.g., smart-phone) when a mobile worker arrives at a work location and wants to personalize the workspace; and (b) resetting a workspace to a default condition when the workspace is no longer used or needed by the mobile worker. Embodiments in accordance with the present invention help enable continuity of the personalized workspace presented to a mobile worker.

Embodiments in accordance with the present invention may use a short-range communication method and channel to transfer sufficient information about an identifier in order for the personalized workspace to be set up or modified. The setup or modification (i.e., personalization) may involve personalizing or customizing personal preferences, employer-granted permissions and accesses, job requirements, associating a telephone number with a particular “ring to” location, and so forth. Short-range communication methods and channels may comprise an optical recognition channel, an infrared transmitter/receiver, or a short-range wireless channel such as a near-field communications (“NFC”) link.

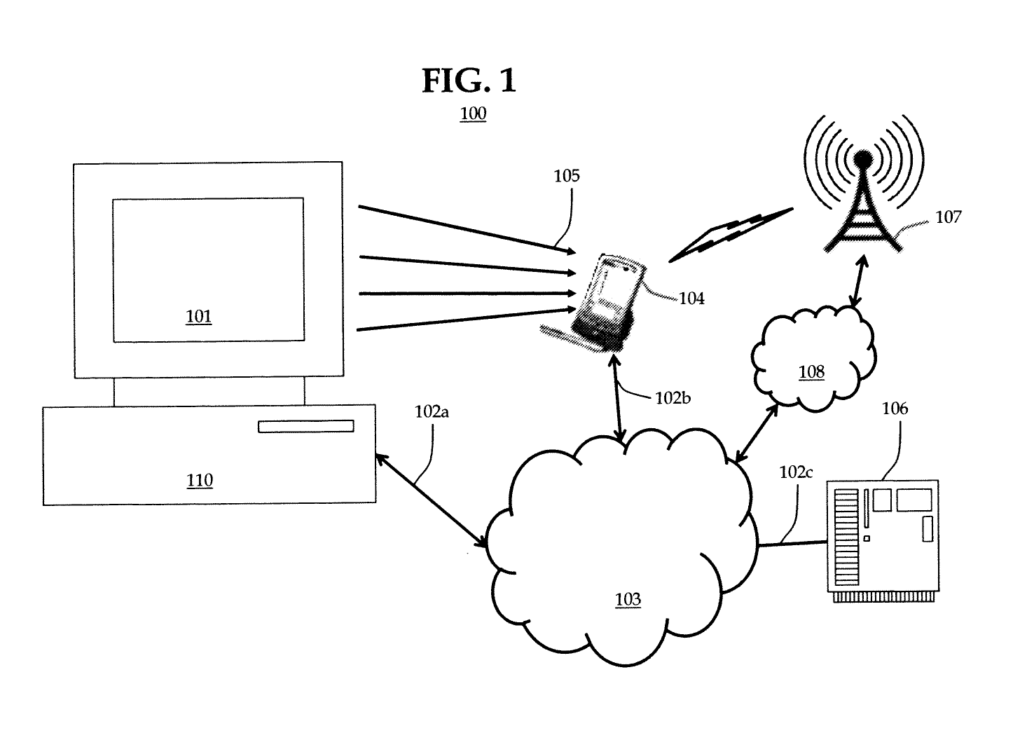

FIG. 1 illustrates a block diagram of a system 100 in accordance with an embodiment of the invention. System 100 comprises a display device 101 that is communicatively coupled to a computing device 110, a mobile device 104, an optional workspace personalization server 106, a cellular telephone network 107, and a public-switched telephone network 108, which are connected as shown in FIG. 1.

In an embodiment, display device 101 is capable of displaying a graphical display, such as a QR code, with sufficient resolution and quality to be recognized by a camera built into mobile device 104, as discussed herein in further detail. Display device 101 and computing device 110 are communicatively coupled together, but may have a variety of physical arrangements. For example, display device 101 and computing device 110 may include a conventional desktop computer as depicted. Alternatively, display device 101 and computing device 110 may be physically integrated together, for instance as a mobile computer, tablet PC, and so forth. Alternatively, display device 101 may include a television, and computing device 110 may include a gaming console (e.g., Xbox™, PlayStation™, Wii™, etc.), or an internet-enabled interface (e.g., a digital video recorder, TiVo, Google TV, etc.). Alternatively, computing device 110 may be separately co-located with display device 101 (e.g., in the same room) but without access to computing device 110 being provided to a user (e.g., by placing display computing device 110 in a locked enclosure. Alternatively, computing device 110 may be remotely located from display device 101 and in communication contact via Ethernet or other networking technology to one or more display devices 101, wherein the display device 101 may include a dumb terminal.

In an embodiment in accordance with the present invention, display device 101 may not be the device or display for the computer that is being personalized. For example, a room may contain more than one computing device 110 and associated display 101 (e.g., two computers, or one computer along with an internet-enabled TV, or one computer with more than one display, etc.). Personalization may be performed by displaying the graphical display on a first display, but the personalization will be with respect to a second display.

Display device 101 is associated with a predetermined, particular workspace or a particular location. Computing device 110, which is communicatively coupled to display device 101, comprises a communication interface to couple computing device 110 to a first communication path 102a, which in turn is coupled to a WAN 103 such as the internet or an intranet. Display device 101 comprises a communication interface to couple display device 101 to a second communication path 105. Although display device 101 and computing device 110 are illustrated as a desktop computer, any computer and display capable of supporting the communication interfaces described herein may be used, as discussed elsewhere herein. Display device 101 and computing device 110 may be used by a mobile worker who is hoteling at a work location, therefore display device 101 and computing device 110 will be the interface through which the mobile worker accesses computer-hosted resources to perform their job. Display device 101 and computing device 110 may also be able to control the workspace environment such as temperature and lighting through an appropriate interface to an intelligent building system (not shown). Alternatively or in addition, computing device 110 may interface to workspace personalization server 106, which then interacts with a building management system to control aspects of the indoor environment such as lighting, temperature, etc.

Computing device 110 may comprise a processor, a memory coupled to the processor, a receiver, transmitter, and/or transceiver to couple an internal and/or external communication path to the processor, and/or one or more user input/output (I/O) devices (e.g., display screen, keyboard, mouse, etc.). The memory stores data and/or program instructions used by the processor. The memory may comprise permanent, non-volatile memory (e.g., ROM), or volatile memory (e.g., RAM), or rewritable memory (e.g., hard drive or flash memory), or any combination thereof. The program instructions, when executed by the processor, carry out the processes performed by computing device 110.

Mobile device 104 comprises a communication interface to couple mobile device 104 to the second communication path 105. Mobile device 104 further comprises an interface to a communication path to a cell phone station 107, which in turn is connected through the public-switched telephone network (PSTN) 108 to WAN 103. Mobile device 104 may further comprise a communication interface to couple mobile device to communication path 102b (e.g., a WiFi link to a WiFi hotspot), which in turn is coupled to WAN 103. Mobile device 104 is ordinarily carried by the mobile worker from one work location to another.

Mobile device 104 may comprise a processor, a memory coupled to the processor, a receiver, transmitter, and/or transceiver to couple an internal and/or external communication path to the processor, and/or one or more user input/output (I/O) devices (e.g., display screen, keyboard, mouse, etc.). The memory stores data and/or program instructions used by the processor. The memory may comprise permanent, non-volatile memory (e.g., ROM), or volatile memory (e.g., RAM), or rewritable memory (e.g., hard drive or flash memory), or any combination thereof. The program instructions, when executed by the processor, carry out the processes performed by mobile device 104.

Workspace personalization server 106 comprises a communication interface to couple workspace personalization server 106 to communication path 102c, which in turn is coupled to WAN 103. Workspace personalization server 106 may execute a server computer program that implements server functions for the workspace personalization capability. Alternatively, computing device 110 may be communicatively connected in a peer-to-peer configuration with mobile device 104 to implement a workspace personalization capability rather than by use of workspace personalization server 106 in a client-server configuration. Workspace personalization server 106 may be used to: authenticate users; store and maintain user preferences; access various systems, such as but not limited to a building management system or a desktop personalization systems, in order to set up a user environment; maintain user data for desktop configuration; maintain user data for desk phones; maintain call records; etc.

Workspace personalization server 106 may comprise a processor, a memory coupled to the processor, a receiver, transmitter, and/or transceiver to couple an internal and/or external communication path to the processor, and/or one or more user input/output (I/O) devices (e.g., display screen, keyboard, mouse, etc.). The memory stores data and/or program instructions used by the processor. The memory may comprise permanent, non-volatile memory (e.g., ROM), or volatile memory (e.g., RAM), or rewritable memory (e.g., hard drive or flash memory), or any combination thereof. The program instructions, when executed by the processor, carry out the processes performed by workspace personalization server 106.

Communication paths 102a -102c to/from WAN 103 may comprise Ethernet, WiFi, Bluetooth, or any combination thereof.

Communication channel 105 is a relatively short-range communication channel between display device 101 and/or computing device 110, and mobile device 104. Communication channel 105 may employ one of a variety of techniques, such as optical, infrared, RF, and so forth.

Embodiments in accordance with the present invention inherently provide some measure of security because of the typically short range at which the optical channel is visible and can be scanned by a scanner. More robust security is provided through encryption of information encoded in the QR code, which can be decrypted by an authentication process performed by workspace personalization server 106.

Computing device 110 may have executing thereon a client computer program or a web application (e.g., a Java program) that provides a personalized workspace capability to a user (i.e., to a person). The communication network 103 may be coupled to a workspace personalization server 106 executing a server computer program that implements server functions for the workspace personalization capability. Alternatively, computing device 110 may be communicatively connected in a peer-to-peer configuration with mobile device 104 in order to implement a workspace personalization capability rather than by use of a client-server configuration.

In the embodiment of FIG. 1, communication channel 105 is a line-of-sight optical channel that is formed by a display of an information-bearing display, such as a 1-D barcode, 2-D barcode, QR code, matrix barcode, Data Matrix code, or the like, on display device 101, which is visible to an image capture capability provided by mobile device 104. A QR code, for instance, is a known type of matrix barcode (i.e., a two-dimensional “2-D” barcode). QR codes have a large storage capacity relative to the data requirements needed to set up a personalized workspace. The QR code comprises dark sections arranged in a square or rectangular pattern on a lighter background. The information-bearing display will be referred to herein generically as a QR code unless the context makes clear that a different meaning is intended. The information encoded can be made up of essentially any kind of digital data. The information-bearing display is optically conveyed from the source of the display to a camera or other image capture apparatus by photons, as known by a person of skill in the art. However, unlike a modulated optical signal employing digital or analog modulation, the optical signal received by the camera or other image capture apparatus is an unmodulated and visually recognizable representation of the image itself and not a modulated representation of the image.

The data encoded in the QR code or the like may comprise data related to an identifier of a workspace location. For example, the information encoded in the information-bearing display may comprise: an identifier such as a location or an address; a MAC address; a user-supplied mnemonic to identify a preferred set workspace personalization (e.g., “home office” or “NY office”, etc.); a security code such as a nonce, and so forth. A nonce may comprise a “contextually unique ID.” For instance, the nonce may be a globally unique identifier (“GUID”), a random number, or a substantially unique number within the context of the application. When personalizing the workspace, display device 101 and/or computing device 110 may use some form of identifier to identify the workspace being personalized. This identifier is communicated in the QR code to the mobile device 104. The content of the QR code is not limited, and may contain additional information such as an encrypted terminal ID, information about workspace personalization server 106, and so forth.

The information-bearing display may also comprise additional information related to the workspace, such as alerts and notices. The information-bearing display may also comprise a URL link to a workspace personalization server such that additional information can be downloaded by the mobile device from the workspace personalization server, at the URL link provided.

When a mobile worker is assigned to a temporary workspace, workspace personalization begins when an I/O-enabled device at the workspace, such as computing device 110, transmits information identifying the location of the workspace and the location (e.g., URL) of a workspace personalization server. The transmission of information may be initiated by a user action, such as a command, menu choice, hot-key, or the like at a computer running a personalization software client, a web application (“app”) (e.g., a Java program), or the like. If display device 101 is not readily available at a workspace location, a QR code can be displayed on other kinds of electronic displays, such as an internet-enabled TV (e.g., in a hotel room), a gaming console, or an LCD display without a computer being present.

Embodiments in accordance with the present invention that are used to personalize a workspace do not suffer certain disadvantages of methods known in the background art, in particular methods such as those based on usage of a proximity-based detector (e.g., RFID reader), the disadvantages including: (a) having to carry an additional token; and (b) needing access to an RFID reader.

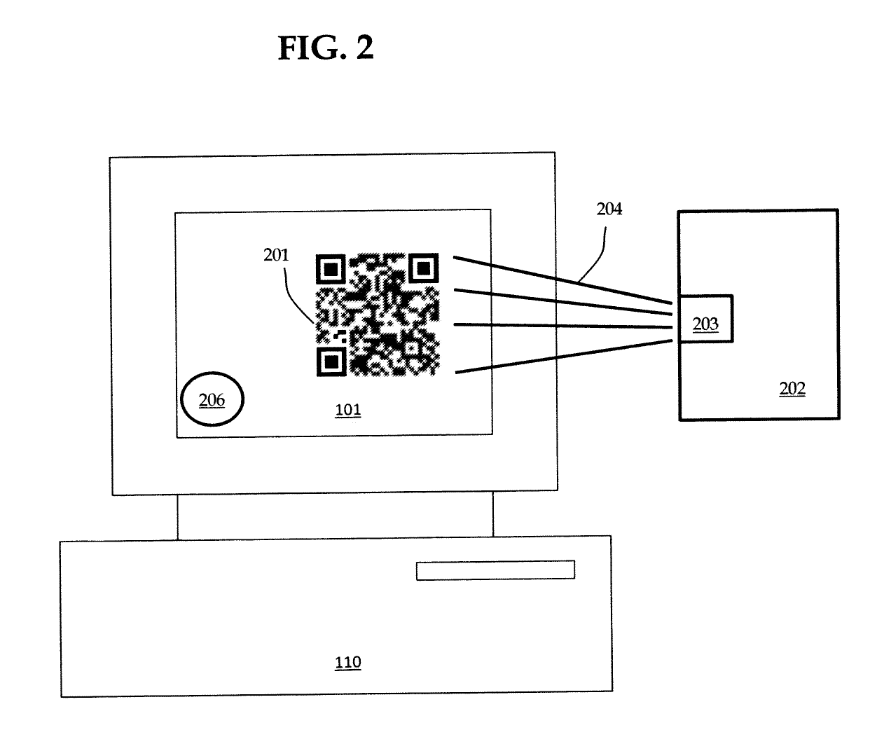

FIG. 2 illustrates a desktop to mobile transfer of information in order to personalize a workspace, in accordance with an embodiment of the present invention. The client computer program or web application (i.e., “web app”) running on computing device 110 may provide a command input 206 on display device 101 such as a link, hotspot, command, menu choice, popup, or the like; or a command input activated though computing device 110 such as a hot key, in order to allow a user to start a workspace personalization process. Upon a command from a user to start the workspace personalization process, the client computer program will gather information that identifies workspace that is to be personalized. The information may be gathered from memory storage, for instance memory storage that is local to computing device 110. The information is then encoded in an information-bearing display 201 that is displayed on display device 101, such as a QR code. However other types of information-bearing displays 201 may be used, such as a 1-D barcode, 2-D barcode, matrix barcode, Data Matrix code, or the like.

In another embodiment in accordance with the present invention, separate displays may be provided, such that a first display is used for inputting a command or action to initiate a personalization process (e.g., using the first display device for displaying a command input 206 as discussed below in connection with FIG. 2, but using a second display device for displaying a QR code.) The first and/or the second displays may be associated with a computing system other than the computing system being personalized.

The user may then manipulate their mobile device 202, in particular a camera 203 associated with mobile device 202, to take a picture or scan of the information-bearing display 201, or to allow the mobile device 202 to recognize the presence of the information-bearing display 201 by way of a line-of-sight optical channel 204 when display 201 is in the field of view of the camera 203. Mobile device 202 has installed thereon an application program (i.e., an “app”) that assists in the transfer of workspace identification information to mobile device 202. Recognition software, which is part of the application program resident in mobile device 202, may recognize information in the information-bearing display 201, and convert the information into a digital format that can be more easily and/or more compactly transmitted over a communication channel in order to establish the personalized workspace settings, as explained below in further detail.

Although the transfer process illustrated in FIG. 2 relies upon a visual medium to transfer information, other embodiments may be used in accordance with the present invention.

In another embodiment, a relatively short-range wireless communication link (e.g., near field communication (“NFC”) or other RF method; or infrared) may be used to transfer information between computing device 110 and mobile device 202, so long as a prior association is not necessary. Wireless communication links used in this way may use additional authentication in order to help ensure that only the intended mobile device 202 receives the transfer information.

In an embodiment in accordance with the present invention, the application on the user's smartphone may store personalization information related to the personalized workspace (e.g., user preferences) as pre-defined settings, and use these pre-defined settings for customization. In another embodiment in accordance with the invention, personalization server 106 may store personalization information related to the personalized workspace as pre-defined settings. The personalization information, whether stored by the smartphone or stored by personalization server 106, may comprise permission or access settings for various application programs or resources, preference settings, and so forth. Personalization information may be based upon the individual identity of the smartphone and/or smartphone user, or may be based upon membership of a group or class, such as “exempt employee”, “supervisor”, “accounting”, and so forth, or any combination thereof.

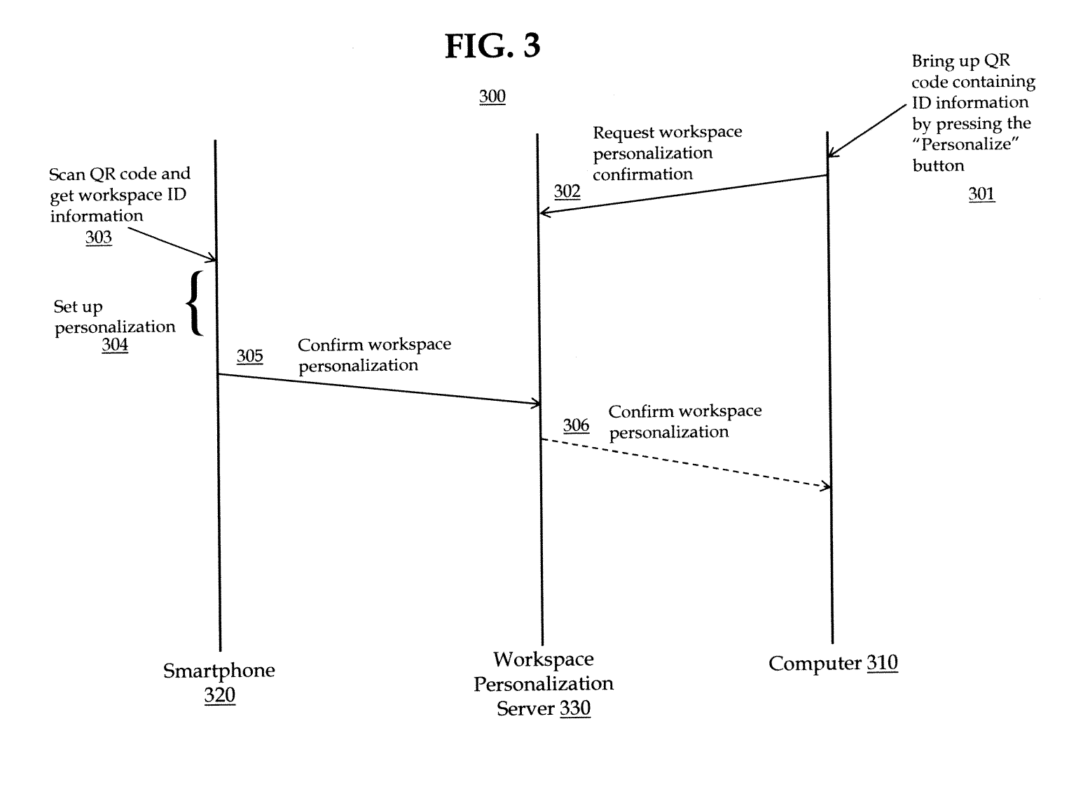

FIGS. 3-6 discussed below describe various embodiments in which personalization settings are stored either on the user's smartphone or on the personalization server 106. FIGS. 3-6 also describe various embodiments in which steps for setting up personalization are carried out by either the user's smartphone or the personalization server 106. It should be understood that portions of settings may also be stored on both the user's smartphone and the personalization server 106, and that portions of the steps for personalization may be carried out by both the user's smartphone and the personalization server 106.

FIG. 3 illustrates a method 300 and messages associated with workspace personalization by use of computer 310 and mobile device 320, through use of workspace personalization server 330, in accordance with an embodiment of the present invention. In the context of a living space as a workspace, computer 310 may comprise a display such as a TV, coupled to a processor that can accept a user command (e.g., a gaming console; or an internet-enabled TV). Method 300 begins when a user at computer 310 wishes to personalize their workspace. The user at step 301 will then command computer 310 to personalize the workspace, for instance by activating a “Personalize” button (i.e., a link, hotkey, etc.) in order to create and display a QR code or other visual transfer medium containing session set-up information. Substantially at the same time, computer 310 may send message 302 to workspace personalization server 330 in order to request a workspace personalization.

At step 303, a user may manipulate smartphone 320 (or other sufficiently enabled mobile device) in order to take a picture, scan, or otherwise recognize the QR code displayed on computer 310. A sufficiently enabled mobile device is one which has a camera and also has an ability to execute an application program such as a QR-recognition app. The QR code contains sufficient information in order to enable smartphone 320 to identify the workspace. At step 304, smartphone 320 sets up the workspace personalization. In this embodiment, personalization settings are stored on smartphone 320 and the setting up of the personalization is done by smartphone 320. This embodiment may be useful when a user is pre-registered with system 100 (e.g., a an employee's regular office).

When the workspace identification information has been received by smartphone 320, then smartphone 320 at step 304 prepares an appropriate workspace personalization message and at step 305 sends an acknowledgement message to workspace personalization server 330 in order to confirm personalization of the workspace associated with computer 310. Optionally, at step 306 the workspace personalization server 330 may send a message to computer 310 in order to confirm the workspace personalization.

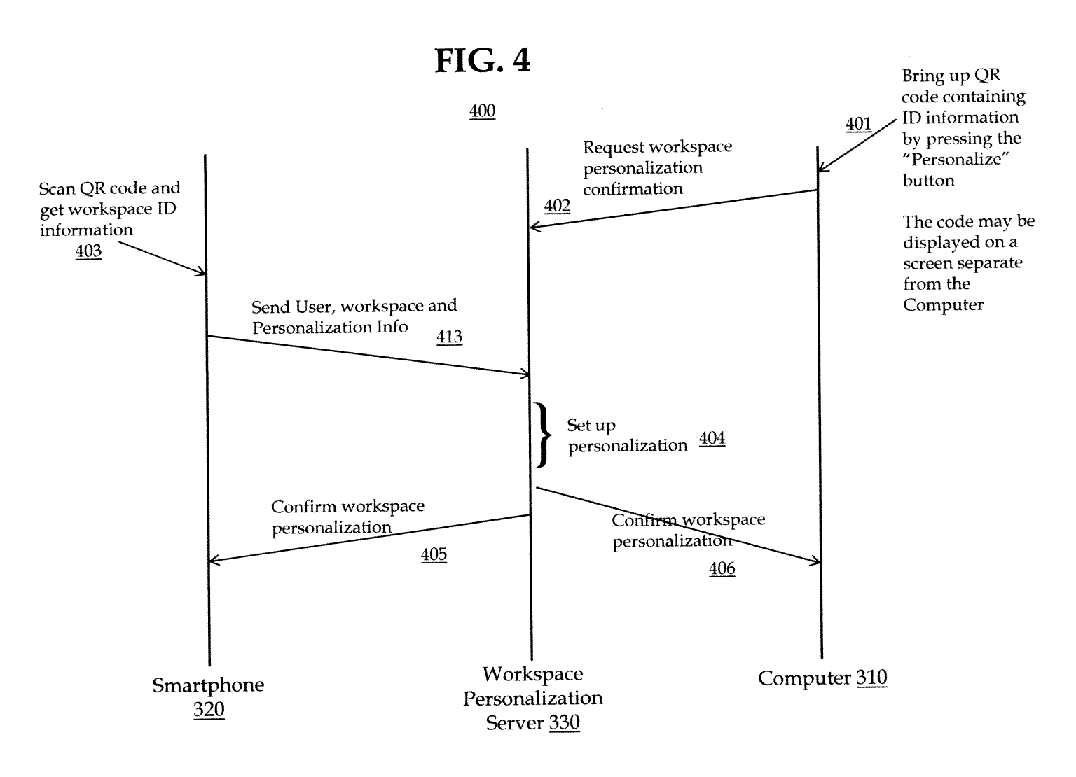

FIG. 4 illustrates a method 400 and messages associated with workspace personalization by use of computer 310 and mobile device 320, through use of workspace personalization server 330, in accordance with an embodiment of the present invention. Method 400 involves personalization execution on server 330, such that the personalization information resides on the smartphone 320. In this embodiment, personalization settings are transmitted to workspace personalization server 330. This embodiment may be useful when a user is not pre-registered with system 100 (e.g., a hotel guest).

Method 400 begins when a user at computer 310 wishes to personalize their workspace. The user at step 401 will then command computer 310 to personalize the workspace, for instance by activating a “Personalize” button (i.e., a link, hotkey, etc.) in order to create and display a QR code or other visual transfer medium containing session set-up information. The QR code may be displayed on a screen that is separate from computer 310. Substantially at the same time, computer 310 may send message 402 to workspace personalization server 330 in order to request a workspace personalization.

At step 403, a user may manipulate smartphone 320 (or other sufficiently enabled mobile device) in order to take a picture, scan, or otherwise recognize the QR code displayed on computer 310. The QR code contains sufficient information in order to enable smartphone 320 to identify the workspace. At step 413 the identity of the workspace, the user's identity and personalization information is sent to personalization server 330. At step 404, personalization server 330 sets up the workspace personalization. At step 406, a confirmation of the workspace personalization is sent to computer 310, and at step 405 a confirmation of the workspace personalization is sent to smartphone 320.

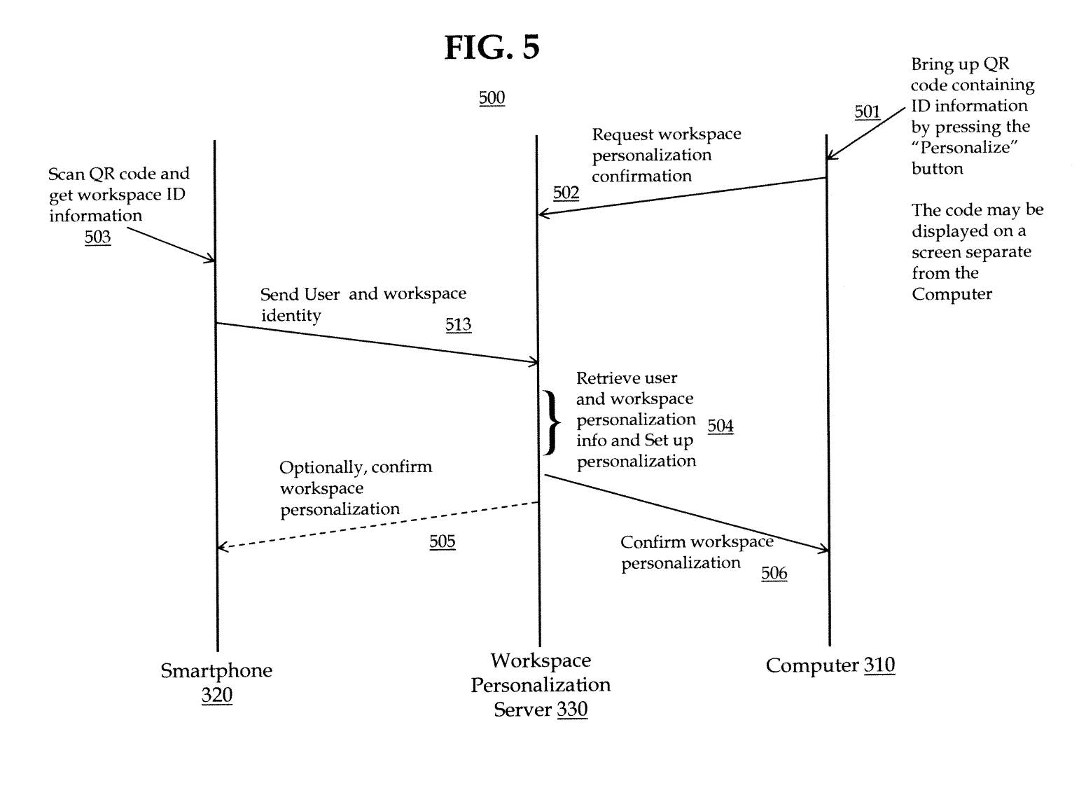

FIG. 5 illustrates a method 500 and messages associated with workspace personalization by use of computer 310 and mobile device 320, through use of workspace personalization server 330, in accordance with an embodiment of the present invention. Method 500 involves personalization settings that are stored on workspace personalization server 330 and are then associated with the user and/or smartphone 320. For example, the user may be an enterprise worker who is already known to the enterprise personalization server. In this case, the user's personalization settings can be pre-entered at workspace personalization server 330 and indexed with user's identity.

Method 500 begins when a user at computer 310 wishes to personalize their workspace. The user at step 501 will then command computer 310 to personalize the workspace, for instance by activating a “Personalize” button (i.e., a link, hotkey, etc.) in order to create and display a QR code or other visual transfer medium containing session set-up information. The QR code may be displayed on a screen that is separate from computer 310. Substantially at the same time, computer 310 may send message 502 to workspace personalization server 330 in order to request a workspace personalization.

At step 503, a user may manipulate smartphone 320 (or other sufficiently enabled mobile device) in order to take a picture, scan, or otherwise recognize the QR code displayed on computer 310. The QR code contains sufficient information in order to enable smartphone 320 to identify the workspace. At step 513 the user's identity and workspace identity is sent to personalization server 330. At step 504, personalization server 330 retrieves the user and workspace and personalization information, and then sets up the workspace personalization. At step 506, a confirmation of the workspace personalization is sent to computer 310, and optionally at step 505 a confirmation of the workspace personalization is sent to smartphone 320.

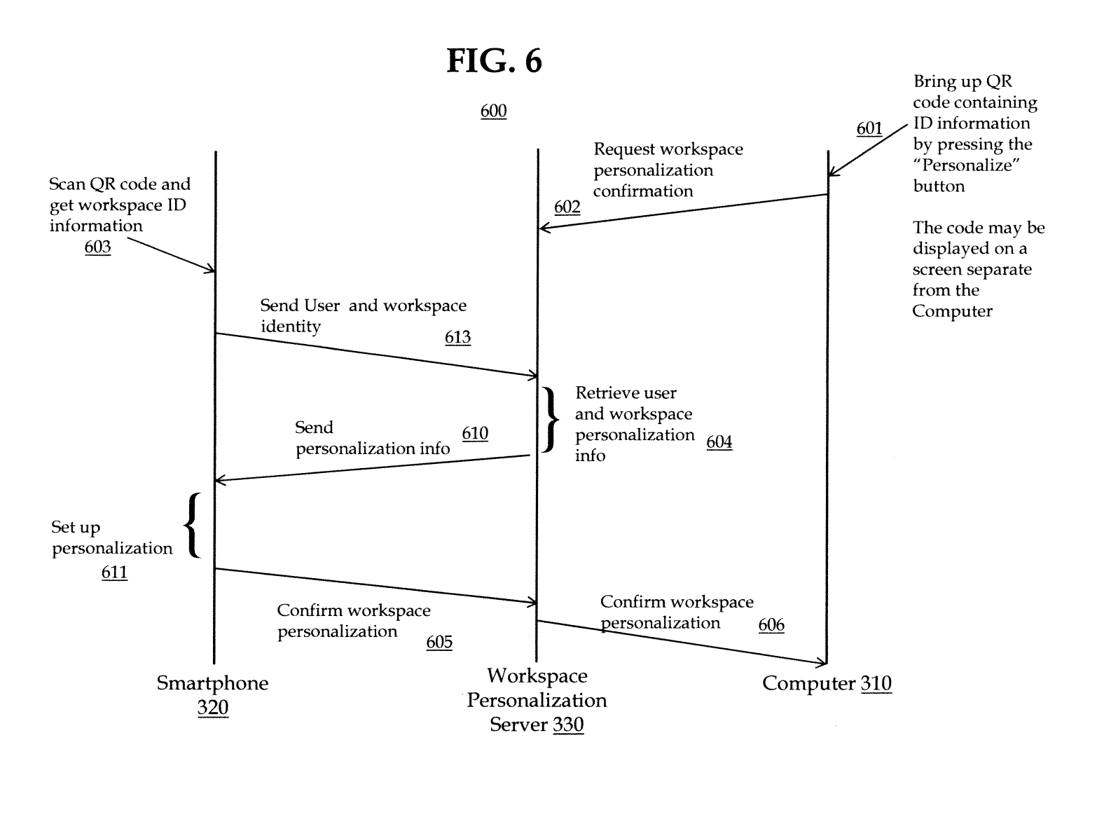

FIG. 6 illustrates a method 600 and messages associated with workspace personalization by use of computer 310 and mobile device 320, through use of workspace personalization server 330, in accordance with an embodiment of the present invention. Method 600 involves personalization execution on personalization server 330, using personalization information stored on workspace personalization server 330.

Method 600 begins when a user at computer 310 wishes to personalize their workspace. The user at step 601 will then command computer 310 to personalize the workspace, for instance by activating a “Personalize” button (i.e., a link, hotkey, etc.) in order to create and display a QR code or other visual transfer medium containing session set-up information. The QR code may be displayed on a screen that is separate from computer 310. Substantially at the same time, computer 310 may send message 602 to workspace personalization server 330 in order to request a workspace personalization.

At step 603, a user may manipulate smartphone 320 (or other sufficiently enabled mobile device) in order to take a picture, scan, or otherwise recognize the QR code displayed on computer 310. The QR code contains sufficient information in order to enable smartphone 320 to identify the workspace. At step 613 the user's identity and workspace identity is sent to personalization server 330. At step 604, personalization server 330 retrieves the user and workspace personalization information from storage associated with personalization server 330. At step 610, the user and workspace personalization information retrieved in step 604 is transmitted to smartphone 320. At step 611, smartphone 320 sets up the workspace personalization based on the information received in step 610. At step 605, a confirmation of the workspace personalization is sent from smartphone 320 to workspace personalization server 330, and then at step 606 a confirmation of the workspace personalization is sent from workspace personalization server 330 to computer 310.

While the foregoing is directed to embodiments of the present invention, other and further embodiments of the present invention may be devised without departing from the basic scope thereof. It is understood that various embodiments described herein may be utilized in combination with any other embodiment described, without departing from the scope contained herein. Further, the foregoing description is not intended to be exhaustive or to limit the present invention to the precise form disclosed. Modifications and variations are possible in light of the above teachings or may be acquired from practice of the present invention.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. §112, ¶6, and any claim without the word “means” is not so intended.

What is claimed is:

1. A method to personalize a workspace, comprising:
receiving via a first communication channel an information message comprising an identification of the workspace; and
sending via a second communication channel: an identity of a user; the identification of the workspace; and a request to personalize the workspace according to settings associated with the user.

2. The method of claim 1, wherein the first communication channel comprises a line-of-sight optical channel from a visual display of the information message to an image sensor.

3. The method of claim 1, wherein the information message comprises a QR code.

4. The method of claim 1, further comprising the step of sending via the second communication channel a confirmation message to confirm a personalization of the workspace.

5. The method of claim 1, wherein the first communication channel comprises a near-field communications channel configured to operate without prior association between a transmitter of the information message and a receiver of the information message.

6. The method of claim 1, wherein the second communication channel comprises a communication channel to a personalization server.

7. The method of claim 6, wherein at least a portion of the settings associated with the user are stored on the personalization server.

8. The method of claim 1, wherein at least a portion of the settings associated with the user are transmitted with the request to personalize the workspace.

9. The method of claim 1, wherein the second communication channel comprises a peer-to-peer communication channel.

10. A method to personalize a workspace, comprising:
receiving via a first communication channel an information message comprising an identification of the workspace;
personalizing the workspace according to settings associated with a user; and;
sending via the second communication channel a confirmation message to confirm a personalization of the workspace.

11. The method of claim 10, further comprising the steps of:
sending via a second communication channel: an identity of the user; and the identification of the workspace; and
receiving via the second communication channel settings associated with the user.

12. A system to personalize a workspace, comprising:
a first, personalizable member comprising: a transmitter of a short-range communication channel, the transmitter configured to transmit an identification of the first personalizable member; and a communication interface configured to receive personalization data;
a second member comprising: a receiver of the short-range communication channel; and a communication interface configured to transmit a personalization request and an identification of the second member; and
a personalization server configured to personalize the workspace of the first member, in response to the personalization request from the second member.

13. The system of claim 12, wherein the short-range communication link comprises a line-of-sight optical channel to convey a visual display of a recognizable optical pattern.

14. The system of claim 12, wherein the short-range communication link comprises a near-field communications channel configured to operate without prior association between a transmitter of an information message and a receiver of the information message.

15. The system of claim 12, wherein at least a portion of personalization settings associated with the personalization request are stored on the personalization server.

16. The system of claim 12, wherein at least a portion of personalization settings associated with the personalization request are transmitted with the personalization request.

17. A method to personalize a workspace, comprising:
receiving a command from a user to personalize the workspace;
sending via a first communication channel an information message comprising an identification of the workspace; and
receiving personalization data via a second communication channel, wherein the personalization data is used to personalize the workspace.

18. The method of claim 17, wherein the first communication channel comprises a line-of-sight optical channel from a visual display of the information message to an image sensor.

19. The method of claim 17, wherein the first communication channel comprises a near-field communications channel configured to operate without prior association between a transmitter of the information message and a receiver of the information message.

20. The method of claim 17, wherein the second communication channel comprises a communication channel to a personalization server.
